(19) United States
(12) Patent Application Publication
(10) Pub. No.: US 2025/0279805 A1
(43) Pub. Date: Sep. 4, 2025

(54) APPARATUS AND METHOD FOR PERFORMING COMMUNICATION BY BASE STATION AND DISTRIBUTED ANTENNA SYSTEM

(71) Applicant: SOLiD, INC., Seongnam-si (KR)

(72) Inventor: HanSeok KIM, Seoul (KR)

(73) Assignee: SOLiD, INC., Seongnam-si (KR)

(21) Appl. No.: 19/004,895

(22) Filed: Dec. 30, 2024

(30) Foreign Application Priority Data
Jan. 2, 2024 (KR) 10-2024-0000235

(51) Int. Cl. H04B 7/022; H04W 24/08

(52) U.S. Cl. CPC H04B 7/022; H04W 24/08

(57) ABSTRACT

A method performed by a first distributed antenna system (DAS) node unit in a communication system including a DAS includes: measuring information related to a delay of at least one second DAS node unit connected to the first DAS node unit; generating delay information for the at least one second DAS node unit based on the information related to the delay; and transmitting the delay information to an open-radio access network (O-RAN) node unit of a base station to which the DAS is connected.

### CROSS-REFERENCE TO RELATED APPLICATIONS

This application claims the benefit of Korean Patent Application No. 10-2024-0000235,filed on Jan. 2, 2024, in the Korean Intellectual Property Office, the disclosure of which is incorporated herein in its entirety by reference.

### BACKGROUND

### 1. Field

The disclosure relates to a distributed antenna system, and more particularly, to a method of a distributed antenna system to communicate with a base station.

### 2. Description of the Related Art

A distributed antenna system (DAS) may primarily serve a role of relaying macro wireless base station signals of a mobile communication service provider. The DAS is a transmission medium such as optical fiber, wired Ethernet, and the like, or a system composed of spatially separated antenna nodes (e.g., a remote unit) connected to a common node (e.g., a head-end unit) through a transmission network.

The DAS may be used to cover wide areas such as buildings, campuses, and stadiums. In particular, the DAS may be installed in an area where radio waves are not received or where radio waves are weak, such as inside buildings, underground buildings, subways, tunnels, apartment complexes in residential areas, stadiums, and the like to extend coverage of a base station by providing mobile communication services to even a shadow area where signals of the base station are difficult to reach.

An open-radio access network (O-RAN) is a radio access network based on new radio (NR) technology, a fifth-generation mobile communication system established by a 3rd generation partnership project (3GPP), and provides a standard for interoperability between distributed units and radio units manufactured by different manufacturers.

The DAS may perform communication by connecting to a base station composed of an open DU (ODU) and an open RU (ORU) provided by the O-RAN. However, because the DAS is not included in the scope of O-RAN standards, communication operations with the DAS are not considered in O-RAN standards, and thus a method for performing communication efficiently is required.

### SUMMARY

Provided are methods of communication between a distributed antenna system and O-RAN base stations connected to the DAS.

Provided are methods of adjusting a cell size through information exchange about DAS through communication with O-RAN base stations.

The disclosure is not limited to the above objective(s), but other objective(s) not described herein may be clearly understood by one of ordinary skill in the art from descriptions below.

According to an aspect of an inventive concept of the disclosure, a method performed by a first distributed antenna system (DAS) node unit in a communication system including a DAS, the method includes: measuring information related to a delay of at least one second DAS node unit connected to the first DAS node unit; generating delay information for the at least one second DAS node unit based on the information related to the delay; and transmitting the delay information to an open-radio access network (O-RAN) node unit of a base station to which the DAS is connected.

In an embodiment, the method may further include receiving identification information indicating the O-RAN node unit from the O-RAN node unit.

In an embodiment, the identification information may include a serial number and an IP address of the O-RAN node unit.

In an embodiment, the method may further include receiving registration information indicating that the O-RAN node unit is connected to the first DAS node unit from the O-RAN node unit.

In an embodiment, the registration information may include a number of the base station, identification information of the O-RAN node unit, and identification information of the first DAS node unit.

In an embodiment, the identification information of the O-RAN node unit may include an IP address or serial number of the O-RAN node unit, and the identification information of the first DAS node unit may include an IP address or serial number of the first DAS node unit.

According to another aspect of an inventive concept of the disclosure, a method performed by an open-radio access network (O-RAN) node unit in a communication system including a distributed antenna system (DAS), the method includes: transmitting identification information of the O-RAN node unit to a first DAS node unit included in the DAS; receiving delay information from the first DAS node unit; and determining an antenna delay value based on the delay information.

In an embodiment, the method may further include transmitting registration information indicating that the O-RAN node unit is connected to the first DAS node unit to the first DAS node unit.

In an embodiment, the registration information may include a number of a base station including the O-RAN node unit, the identification information of the O-RAN node unit, and identification information of the first DAS node unit, the identification information of the O-RAN node unit may include an IP address or serial number of the O-RAN node unit, and the identification information of the first DAS node unit may include an IP address or serial number of the first DAS node unit.

In an embodiment, the identification information may include the serial number and IP address of the O-RAN node unit, and the O-RAN node unit may be a distributed unit of a base station that is communicatively connected to the first DAS node unit.

According to another aspect of an inventive concept of the disclosure, a method performed by a first distributed antenna system (DAS) node unit in a communication system including a DAS, the method includes: measuring information related to a delay of at least one second DAS node unit connected to the first DAS node unit; generating delay information for the at least one second DAS node unit based on the information related to the delay; and transmitting the delay information to an open-radio access network (O-RAN) node unit of a base station to which the DAS is connected through a DAS management system entity.

In an embodiment, the method may further include receiving identification information indicating the O-RAN node unit from the O-RAN node unit of the base station through the DAS management system entity.

In an embodiment, the identification information may include a serial number and an IP address of the O-RAN node unit.

In an embodiment, the method may further include receiving registration information indicating that the O-RAN node unit is connected to the first DAS node unit from the O-RAN node unit through the DAS management system entity.

In an embodiment, the registration information may include a number of the base station, identification information of the O-RAN node unit, and identification information of the first DAS node unit.

In an embodiment, the identification information of the O-RAN node unit may include an IP address or serial number of the O-RAN node unit, and the identification information of the first DAS node unit may include an IP address or serial number of the first DAS node unit.

According to another aspect of an inventive concept of the disclosure, a method performed by an open-radio access network (O-RAN) node unit in a communication system including a distributed antenna system (DAS), the method includes: transmitting identification information of the O-RAN node unit to a DAS management system entity; receiving delay information from the DAS management system entity; and determining an antenna delay value based on the delay information.

In an embodiment, the method may further include transmitting registration information indicating that the O-RAN node unit is connected to a first DAS node unit of the DAS to the DAS management system entity.

In an embodiment, the registration information may include a number of a base station including the O-RAN node unit, the identification information of the O-RAN node unit, and identification information of the first DAS node unit, the identification information of the O-RAN node unit may include an IP address or serial number of the O-RAN node unit, and the identification information of the first DAS node unit may include an IP address or serial number of the first DAS node unit.

In an embodiment, the identification information may include the serial number and IP address of the O-RAN node unit, and the O-RAN node unit may be a distributed unit of a base station that is communicatively connected to the DAS management system entity.

According to embodiments, a cell range of a base station may be efficiently adjusted by exchanging distance information of a DAS through communication with a distributed antenna system and an O-RAN base station.

Effects obtainable by the methods according to the inventive concept are not limited to the effect(s) described above, but other effects not described herein may be clearly understood by those of ordinary skilled in the art from the above descriptions.

### BRIEF DESCRIPTION OF THE DRAWINGS

These and/or other aspects will become apparent and more readily appreciated from the following description of the embodiments, taken in conjunction with the accompanying drawings in which:

FIGS. 1A and 1B are block diagrams of a communication system according to an embodiment;

FIGS. 2A to 2C are block diagrams illustrating examples of topologies of distributed antenna systems according to various embodiments;

FIGS. 3A to 3D are block diagrams of elements of a communication system according to an embodiment;

FIG. 4 is a block diagram of a communication system according to an embodiment; and

FIGS. 5 and 6 are flowcharts for explaining an operating method of the communication system illustrated in FIG. 4.

### DETAILED DESCRIPTION

In the existing communication system, a system according to open-radio access network (O-RAN) standards and a distributed antenna system (DAS) are designed to be controlled as separate systems. That is, even if the DAS is connected to the system according to the O-RAN standards, an O-RAN system is configured so that communication may be performed to a target terminal without special consideration of this.

Therefore, because the O-RAN system is designed to control communication by considering various cases such as the connection of the DAS, an antenna delay with a sufficient value considering a maximum delay for a configuration such as a cell size is set. In this case, because the antenna delay is set to a non-optimal value and needs to be set for all sites rather than a specific site, unnecessary communication resources are wasted, communication performance is reduced, and problems such as exceeding a buffering allowance may occur depending on product characteristics.

In order to solve these problems, various aspects of the disclosure propose techniques in which an O-RAN base station determines an antenna delay by considering a delay time of a DAS section using certain information provided from a DAS.

In various embodiments, the technologies described in the disclosure and systems and devices for implementation thereof may utilize other radio access technologies such as WiFi or WiMax as well as radio access technologies such as code division multiple access (CDMA), time division multiple access (TDMA), frequency division multiple access (FDMA), orthogonal FDMA (OFDMA), single-carrier FDMA (SC-FDMA), LTE, a global system for mobile communications (GSM), 5G NR, and the like to support communication between networks (or systems).

Various other embodiments and features according to the inventive concept of the disclosure will be further described later below. It should be apparent that the teachings herein may be implemented in a wide variety of forms and any particular structure, function, or both, disclosed herein are merely exemplary, and not limiting. Based on the teachings herein, those of ordinary skill in the art will appreciate that aspects disclosed herein may be implemented independently of any other aspects, and two or more of these aspects may be combined in various ways. For example, a device or a method may be implemented by using any number of aspects set forth herein. Furthermore, the device or the method may be implemented with structures and functions of one or more of the aspects described herein, or may be implemented by using structures and functions of other aspects. For example, the method may be implemented as a part of commands stored on a non-transitory computer-readable recording medium for execution on a system, a device, an apparatus and/or a processor, or a computer. Furthermore, one aspect may include at least one component of the claim.

Hereinafter, embodiments of the disclosure will be described in detail with reference to the accompanying drawings. At this time, it should be noted that the same components in the attached drawings are indicated by the same symbols as much as possible. In addition, detailed descriptions of well-known functions and configurations that may obscure the gist of the disclosure will be omitted.

In describing the embodiments in this specification, descriptions of technical content that is well-known in the art and not directly related to the disclosure will be omitted. This is to convey the gist of the disclosure more clearly without obscuring it by omitting unnecessary explanation.

For the same reason, some components are exaggerated, omitted, or schematically shown in the accompanying drawings. In addition, the size of each component does not entirely reflect its actual size. In each drawing, identical or corresponding components are given the same reference numerals.

Advantages and features of the disclosure, and implementation methods thereof will be clarified through following embodiments described with reference to the accompanying drawings. In this regard, an embodiment of the inventive concept may have different forms and should not be construed as being limited to the descriptions set forth herein. Accordingly, the embodiments are merely described below, by referring to the figures, to explain aspects. Like reference numerals refer to like elements throughout.

At this time, it will be understood that each block of processing flow charts and combinations of the processing flow charts may be performed by computer program instructions. Because these computer program instructions may be mounted on a processor of a general-purpose computer, special-purpose computer, or other programmable data processing equipment, the instructions performed through the processor of the computer or other programmable data processing device creates a unit to perform functions described in flow chart block(s). These computer program instructions may also be stored in computer-usable or computer-readable memory that can be directed to a computer or other programmable data processing equipment to implement the functions in a particular manner. Accordingly, the instructions stored in the computer-usable or computer-readable memory may also produce manufactured items containing an instruction unit that performs the functions described in the flow chart block(s). Because the computer program instructions can be mounted on a computer or other programmable data processing equipment, instructions that execute a computer or other programmable data processing equipment by performing a series of operations on a computer or other programmable data processing equipment to generate a computer-executable process may also provide operations for executing the functions described in the flow chart block(s).

In addition, each block may represent a module, segment, or portion of code containing one or more executable instructions for executing specified logical function(s). In addition, in some alternative implementations, it should be noted that functions mentioned in the blocks to occur out of order. For example, two blocks shown in succession may be performed substantially simultaneously, or the blocks may sometimes be performed in reverse order depending on their corresponding functions.

At this time, a term “unit” used in the present embodiment means software or hardware components such as field-programmable logic array (FPLA) and application-specific integrated circuit (ASIC), and the “unit” performs a particular function. However, the “unit” is not limited to software or hardware. The “unit” may be configured to be stored in an addressable storing medium or to play back one or more processors. Accordingly, the “unit” may include, for example, software components, object-oriented software components, components such as class components and task components, processors, formulas, attributes, procedures, subroutines, segments of program codes, drivers, firmware, micro codes, circuits, data, database, data structures, tables, arrays and variables. Functions provided in components and “units” may be combined into a smaller number of components and “units”, or may be further divided into additional components and “units.” Furthermore, components and “units” may be implemented to reproduce one or more central processing units (CPUs) within a device or a secure multimedia card.

Hereinafter, a base station is an entity that performs resource allocation for a terminal and may be at least one of a Node B, base station (BS), eNode B (eNB), gNode B (gNB), a radio access unit, a base station controller, or a node on a network. The terminal may include user equipment (UE), a mobile station (MS), a cellular phone, a smartphone, a computer, or a multimedia system capable of performing communication functions. In addition, the embodiment described below may be applied to other communication systems having a similar technical background or channel type as the embodiment. In addition, the embodiment may be applied to other communication systems through some modifications without significantly departing from the scope of the disclosure, at the discretion of one of ordinary skill in the art.

Terms used in the following description, such as terms for identifying a connection node, terms referring to network entities or network functions (NFs), terms referring to messages, terms referring to interfaces between network objects, and terms referring to various identification information, are provided as examples for convenience of explanation. Therefore, the disclosure is not limited to the terms described below, and other terms referring to objects having equivalent technical meaning may be used.

For convenience of explanation below, some terms and names defined in 3rd generation partnership project (3GPP) long-term evolution (LTE) standards may be used. However, the disclosure is not limited by the above terms and names, and may be equally applied to systems according to other standards.

Hereinafter, various embodiments according to the inventive concept of the disclosure will be described in detail one by one.

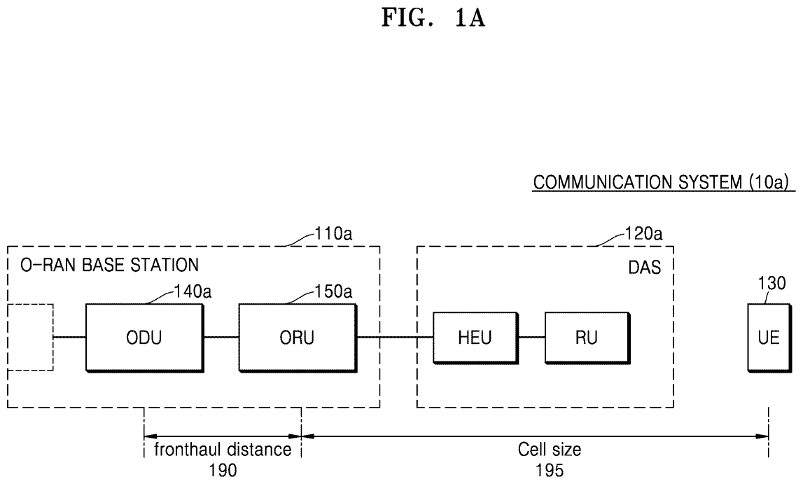

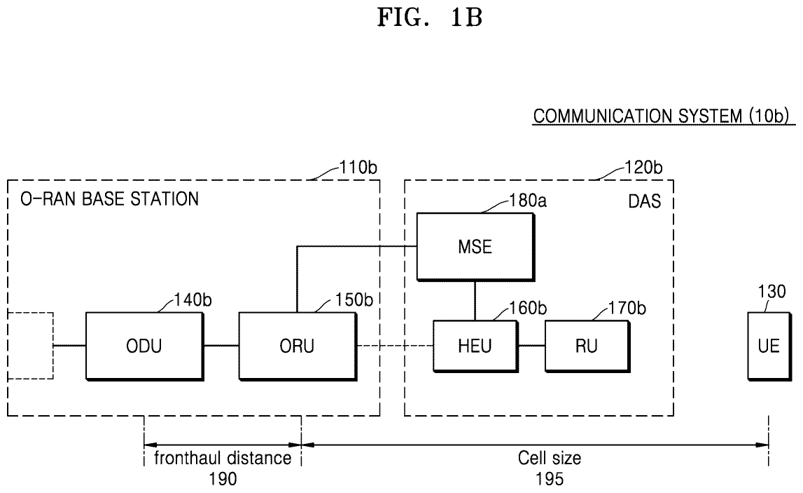

FIGS. 1A and 1B are block diagrams of a communication system according to an embodiment.

Communication systems 10a and 10b may include O-RAN base stations 110a and 110b, distributed antenna systems (DASs) 120a and 120b, and a terminal 130, respectively.

The communication systems 10a and 10b may allow radio resources, such as operating frequencies, power limits, and geographical areas, to be dynamically allocated to multiple terminals associated with the distributed antenna systems 120a and 120b under the control of the O-RAN base stations 110a and 110b.

Although the O-RAN base stations 110a and 110b are described as O-RAN base stations in the expression, it is obvious that base stations in a field where general communication technologies (LTE, NR, Wi-Fi, etc.) other than O-RAN are applied may also be included.

The O-RAN base stations 110a and 110b may include at least one of O-RAN distributed units (ODUs) 140a and 140b, O-RAN radio units (ORUs) 150a and 150b, and a management system entity (MSE) 180, respectively. The ODUs 140a and 140b, the ORUs 150a and 150b, and the MSE 180 may be electrically connected to each other. According to another embodiment, the MSE 180 may not be included in an O-RAN base station but may be configured as a separate entity. In the disclosure, it is illustrated that only ODU, ORU or the MSE 180 is included in an O-RAN base station, but it is obvious that various entities (a centralized unit (CU), RAN intelligent controller RIC, etc.) included in an actual O-RAN standard may be included. In addition, although it is expressed as an O-RAN base station in the disclosure, it may include the entire O-RAN structure and may include a base station used in general LTE, 5G, etc., not an O-RAN standard.

The O-RAN base stations 110a and 110b may be devices that provide radio services using any radio access technology, such as a base station, an access point, or any type of radio frequency (RF) access system.

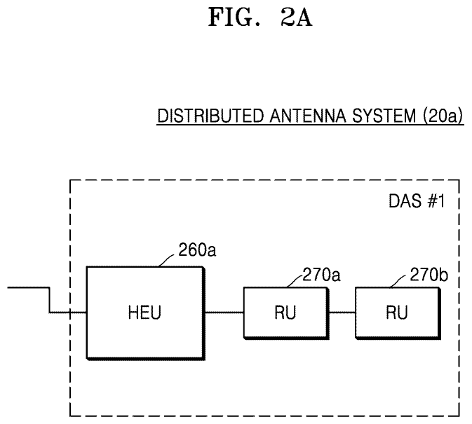

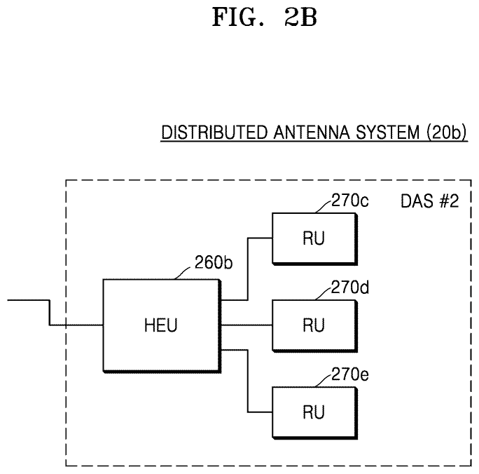

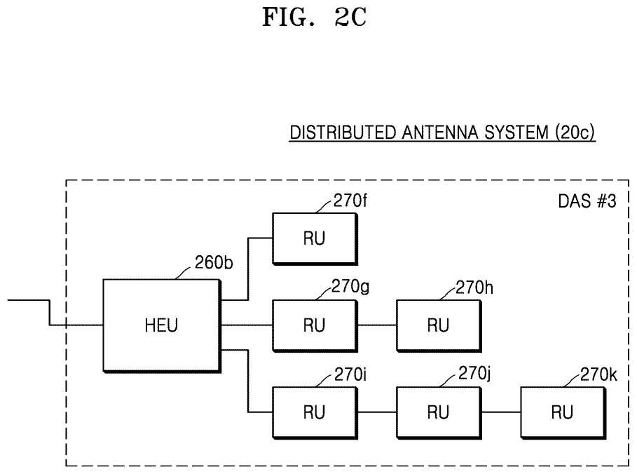

The O-RAN base stations 110a and 110b may be connected to at least one distributed antenna system. In the case of FIGS. 1A and 1B, each of the O-RAN base stations 110a and 110b is illustrated as being connected to one distributed antenna system, but it is also possible for the O-RAN base stations 110a and 110b to be simultaneously connected to a plurality of DAS structures disclosed in FIGS. 2A to 2C.

Each of distances between the ODUs 140a and 140b and the ORUs 150a and 150b in the O-RAN base stations 110a and 110b may be defined as a fronthaul distance 190. In general, the fronthaul distance 190 may be determined as a distance between an ODU and an ORU.

The O-RAN base stations 110a and 110b may determine a cell size 195 for performing communication. In general, a cell size may be set to a certain distance from the O-RAN base stations 110a and 110b. The cell size 195 may be subject to constraints based on random access channel (RACH) signal processing standards or guard time constraints in a case of time division duplex (TDD). For example, a cell size may be determined to be 15 km for LTE and 2 to 5 km for 5G NR according to the RACH signal processing standards. In addition, in the case of TDD, the guard time constraints may be determined to be 12 km for LTE and 5 km for 5G NR. Depending on the determined cell size 195, a configuration inside the DAS may be restricted. That is, depending on constraints on a cell size, when a distributed antenna system is connected to an O-RAN base station, an allowable distance between a DAS headend unit and a DAS remote unit may be limited.

The O-RAN base stations 110a and 110b may determine an antenna delay value for performing communication with the terminal 130. For example, when the ODUs 140a and 140b determine a fixed value corresponding to a delay of a distributed antenna system section and transmit the fixed value to the ORUs 150a and 150b as a parameter value (e.g., a tda parameter value), the ORUs 150a and 150b may reduce a buffering delay by the corresponding parameter value. However, because the conventional O-RAN base station does not transmit or receive special information with a distributed antenna system in relation to a corresponding delay value, an antenna delay value may be determined arbitrarily without considering a situation of the distributed antenna system connected to the conventional O-RAN base station. That is, depending on an installation environment of a distributed antenna system, delays of sections of a plurality of distributed antenna systems may be different, but because information about each of a plurality of distributed antenna systems connected to the ORUs 150a and 150b is not received, the same antenna delay value is set for all distributed antenna systems.

When an O-RAN base station does not interoperate with a distributed antenna system, if the same antenna delay value is set for all ORUs, a maximum delay value for each site of a distributed antenna system section measured by a headend unit of the distributed antenna system is not reflected, so the O-RAN base station needs to determine an antenna delay value that is sufficiently large to cover all delay values. In this case, the type and characteristics of a product installed may differ depending on the site (e.g., a buffering allowance for delay compensation), and a difference in a maximum distance between a headend unit and a DAS remote unit may be large. That is, by applying a sufficiently large delay value to all sites, a problem that exceeds an allowable range of buffering may occur depending on product characteristics, which may result in poor communication quality and waste of resources. In order to solve the above problem, it will be described in detail below.

Referring to FIGS. 1A and 1B, the ORUs 150a and 150b may be communicatively connected to the ODUs 140a and 140b, an MSE 180a, and headend units 160a and 160b. In addition, the ORUs 150a and 150b may be electrically connected to the ODUs 140a and 140b and the MSE 180a, and may be physically connected to headend units 160a and 160b. For example, the ORUs 150a and 150b may be connected to the headend units 160a and 160b via a copper wire.

The ORUs 150a and 150b may be named a DAS interface unit DIU.

According to an embodiment, the ORUs 150a and 150b may transmit an ORU identifier and information indicating which headend unit an ORU is connected to to the headend units 160a and 160b or the MSE 180a. The ORU identifier may include information such as a serial number, IP address, and ORU ID of the ORUs 150a and 150b. Information indicating which headend unit an ORU is connected to may be represented as ORU registration information. For example, the ORU registration information may include an SITE number (or a base station number), an IP address of the ORU, and an IP address of a headend. That is, the registration information may be represented as {Site #17, ORU #110.20.1.8, HE #110.20.2.1}.

According to an embodiment, the ORUs 150a and 150b may receive delay information from the headend units 160a and 160b or an MSE 180b to farthest DAS remote units 170a and 170b measured by the headend units 160a and 160b. The ORUs 150a and 150b may determine an antenna delay value (e.g., an external antenna delay) based on the received delay information.

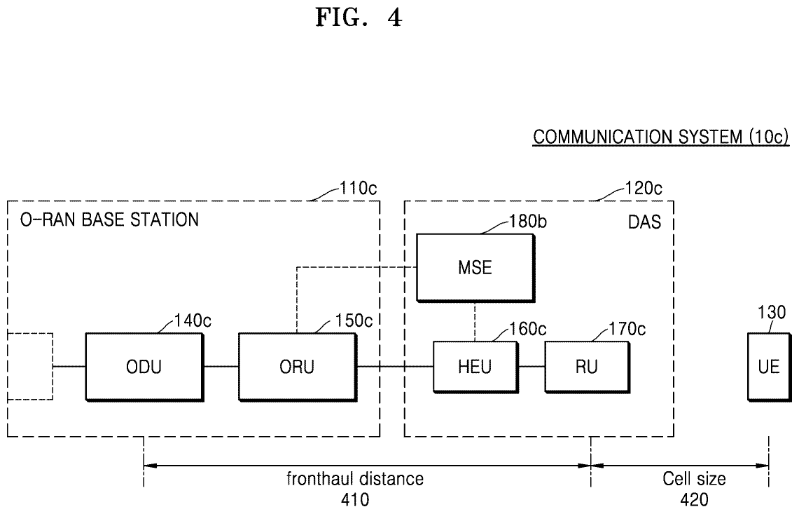

In an embodiment, the O-RAN base stations 110a and 110b may determine various parameters for performing communication based on distance information (or delay information) received from the DASs 120a and 120b. For example, by measuring a starting point of a cell differently, an effect of expanding a size of the entire cell may be achieved even if the cell size is limited. This will be described in more detail with reference to FIG. 4 below.

Referring to FIG. 1B, the communication system 10b may include the MSE 180a. The MSE 180a may be communicatively connected to the ORU 150b and the headend unit 160b. The MSE 180a may be included in the O-RAN base station 110b or the distributed antenna system 120b. The MSE 180a may be configured as a separate entity physically distinct from the O-RAN base station 110b or the distributed antenna system 120b.

According to an embodiment, the MSE 180a may receive an ORU identifier and information indicating which headend unit an ORU is connected to from the ORU 150b. The MSE 180a may forward the received ORU identifier and information indicating which headend unit an ORU is connected to to a headend unit. The ORU identifier may include information such as a serial number, IP address, and ORU ID of the ORUs 150a and 150b. Information indicating which headend unit an ORU is connected to may be represented as ORU registration information. For example, the ORU registration information may include a SITE number (or base station number), an IP address of the ORU, and an IP address of a headend. That is, the registration information may be represented as {Site #17, ORU #110.20.1.8, HE #110.20.2.1}.

According to an embodiment, the MSE 180a may receive delay information from the headend unit 160b to the farthest DAS remote unit 170b measured by the headend unit 160b and transmit the delay information to the ORU 150b.

The MSE 180a may be an entity for integrated management and operation of the distributed antenna systems 120a and 120b as described above, but is not limited thereto. In an embodiment, the MSE 180a may be a network management system or a DAS management system provided by a manufacturer of the distributed antenna system 120b. In another embodiment, the MSE 180a may be a network management system provided by a manufacturer of the O-RAN base station 110b.

The distributed antenna systems 120a and 120b may combine or distribute wireless communication services provided by the O-RAN base stations 110a and 110b and provide them to end user terminals within coverage.

According to an embodiment, the distributed antenna systems 120a and 120b may include the headend units (HEUs) 160a and 160b connected to the O-RAN base stations 110a and 110b, and remote units (RUs) (or DAS RUs) 170a and 170b connected to the headend units (HEUs) 160a and 160b in a point-to-multipoint structure.

The distributed antenna systems 120a and 120b may provide radio services from the O-RAN base stations 110a and 110b to end user terminals by using radio resources allocated under direct or indirect control of a system controller. The distributed antenna systems 120a and 120b may be configured in various structures, which will be described in detail in FIGS. 2A to 2C.

Referring to FIGS. 1A and 1B, the headend units 160a and 160b may be connected to the O-RAN base stations 110a and 110b. The headend units 160a and 160b may be connected to the O-RAN base stations 110a and 110b by wire.

Referring to FIG. 1A, the headend unit 160a may be communicatively connected to the ORU 150a of the O-RAN base station 110a and at least one DAS remote unit 170a. The ORU 150a may be connected to the headend unit 160a by wire. For example, they may be connected to each other via a copper wire. Referring to FIG. 1B, the headend unit 160a may be communicatively connected to the MSE 180a.

According to an embodiment, the headend units 160a and 160b may receive an ORU identifier and information indicating which headend unit an ORU is connected to from the ORUs 150a and 150b. The ORU identifier may include information such as a serial number, IP address, and ORU ID of the ORUs 150a and 150b. Information indicating which headend unit an ORU is connected to may be represented as ORU registration information. For example, the ORU registration information may include a SITE number (or base station number), an IP address of the ORU, and an IP address of a headend. That is, the registration information may be represented as {Site #17, ORU #110.20.1.8, HE #110.20.2.1}.

According to an embodiment, the headend units 160a and 160b may receive an ORU identifier and information indicating which headend unit an ORU is connected to from the ORUs 150a and 150b through the MSE 180a.

According to an embodiment, the headend units 160a and 160b may measure a delay (or delay time) to the DAS remote units 170a and 170b located farthest from at least one connected DAS remote units 170a and 170b connected to the headend units 160a and 160b. The headend units 160a and 160b may generate delay information (or delay time information) based on the measured delay (or delay time) and transmit it to the ORUs 150a and 150b. Alternatively, the headend units 160a and 160b may transmit the delay information (or delay time information) to the ORUs 150a and 150b through the MSE 180a based on the measured delay (or delay time).

The DAS remote units 170a and 170b of FIG. 1A and FIG. 1b, unlike a remote radio head, which is an RF processing device of a distributed base station, may integrate and process multiple radio services, and accordingly, in FIG. 1, only an embodiment in which the DAS remote units 170a and 170b are connected to one of the O-RAN base stations 110a and 110b is illustrated, but the DAS remote units 170a and 170b may be connected directly to a plurality of radio service devices (e.g., base stations) or with a certain network interposed therebetween.

The DAS remote units 170a and 170b may include at least one antenna (not shown) connected thereto by wire. For example, the DAS remote units 170a and 170b may be connected to the antenna by a copper wire. The DAS remote units 170a and 170b may be communicatively connected to the headend units 160a and 160b.

According to an embodiment, the DAS remote units 170a and 170b may be configured to cause the headend units 160a and 160b to perform an operation for measuring a delay (or delay time).

The terminal 130 of FIGS. 1A and 1B illustrates user equipment (UE) located at an edge portion according to a determined cell size of the O-RAN base stations 110a and 110b. Therefore, in general, a distance from the ORUs 150a and 150b to the UE 130 may be determined as a cell size. The cell structure may be determined in various ways depending on the setting, but is generally determined as a circle, and the cell size may represent a radius of the cell.

The UE 130 may receive communication data transmitted through the antenna connected to the DAS remote units 170a and 170b.

According to the inventive concept of the disclosure, elements of the communication systems 10a and 10b, that is, the number of node units (headend units, remote units, MSEs, etc.) constituting a distributed antenna system, and their connection topologies are not limited to the embodiment shown in FIG. 1, and various modifications and variations are possible.

FIGS. 2A to 2C are block diagrams illustrating examples of topologies of distributed antenna systems according to various embodiments. Headend units 260a to 260c and DAS remote units 270a to 270k described in FIGS. 2A to 2C may be the same as the headend units 160a and 160b and the DAS remote units 170a and 170b described in FIG. 1.

Referring to FIGS. 2A to 2C, distributed antenna systems 20a to 20c may include the headend units 260a to 260c and the DAS remote units 270a to 270k. According to another embodiment, the distributed antenna systems 20a to 20c may also include a DAS management system (not shown).

Referring to FIG. 2A, the first distributed antenna system 20a may include the headend unit 260a, the remote unit 270a connected to the headend unit 260a, and the DAS remote unit 270b connected to the remote unit 270a in a daisy chain structure or a cascade structure. The DAS remote units 270a and 270b may be capable of integrated processing of multiple radio services, and accordingly, although FIG. 2A only illustrates an embodiment in which the DAS remote units 270a and 270b are connected to one headend unit 260a, they may be connected directly to a plurality of headend units or with a certain network unit interposed therebetween.

Referring to FIG. 2B, the second distributed antenna system 20b may include the headend unit 260b and the DAS remote units 270c to 270e connected to the headend unit 260b in a point-to-multipoint structure.

Referring to FIG. 2C, the third distributed antenna system 20c may include the headend unit 260c, DAS remote units 270f to 270i connected to a headend unit 130a in a point-to-multipoint structure, and the DAS remote units 270h, 270j, and 270k, each of which is connected to a corresponding remote unit among the DAS remote units 270g and 270i in a daisy chain structure or a cascade structure.

Although not shown, the distributed antenna systems 20a to 20c may optionally further include a DAS management system, and the DAS management system may be communicatively connected to the headend units 260a to 260c.

The distributed antenna systems 20a to 20c may provide radio services to end user devices by using radio resources allocated under direct or indirect control from an O-RAN base station.

According to the inventive concept of the disclosure, the number of node units (headend units and DAS remote units) constituting the distributed antenna systems 20a to 20c and their connection topologies are not limited to the examples shown in FIGS. 2A to 2C, and various changes and modifications are possible.

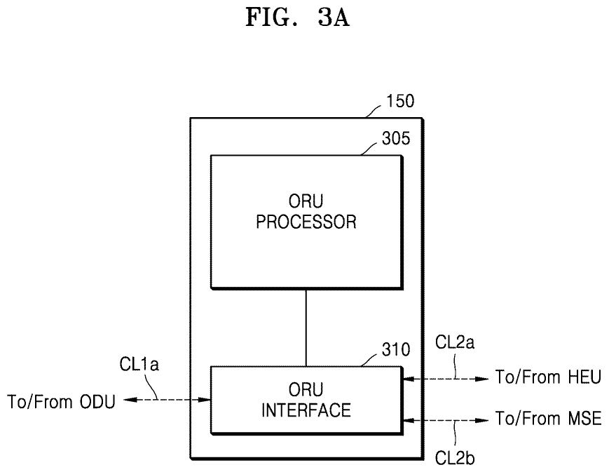

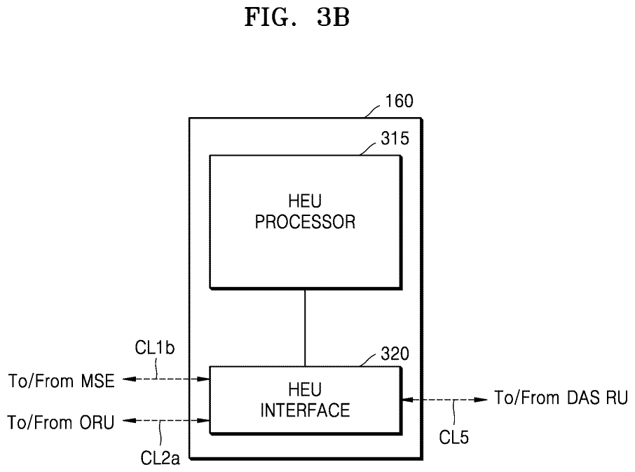

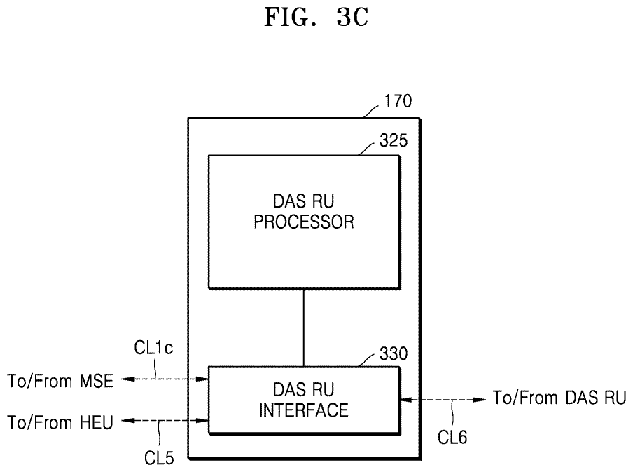

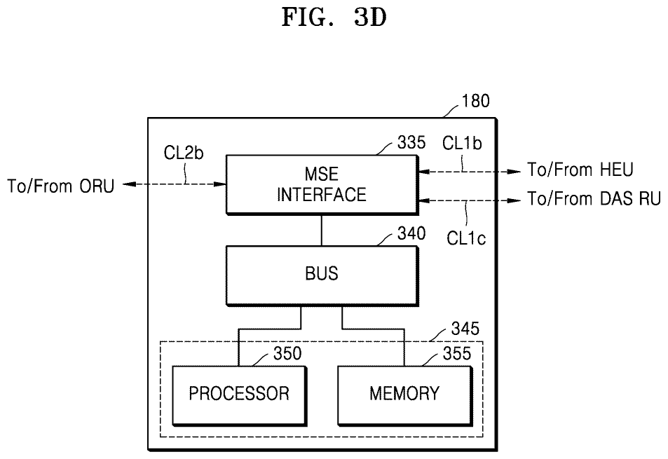

FIGS. 3A to 3D are block diagrams of elements of a communication system according to an embodiment. In describing FIGS. 3A to 3D, because the same reference numerals as in FIGS. 1A and 1B represent the same reference numerals, FIGS. 1A and 1B are referred to together, but redundant descriptions are omitted.

Referring to FIG. 3A, the ORU 150 included in an O-RAN base station may include an ORU processor 305 and an ORU interface 310.

The ORU processor 305 may include, although not shown, a controller that controls all procedures to perform an operation of an ORU in a communication system according to an embodiment, and a converter for converting service signals.

The ORU processor 305 may generate an ORU identifier and information indicating which headend unit an ORU is connected to.

The ORU processor 305 may determine an antenna delay value based on delay information (or delay time information) received from the MSE 180 or a headend unit 160.

The ORU interface 310 is for the ORU 150 to transmit and receive information necessary for improving cell size constraints to and from an ODU 140, the headend unit 160, and the MSE 180.

The ORU interface 310 may transmit an ORU identifier and information indicating which headend unit an ORU is connected to to the headend unit 160 or the MSE 180.

That is, the ORU 150 may transmit and receive the information to and from the ODU 140 connected through a first communication link CL1a, and the headend unit 160 and the MSE 180 connected through second communication links CL2a and CL2b, respectively, by using the ORU interface 310.

Here, the first communication link CL1a and the second communication links CL2a and CL2b may be, for example, the Internet, but are not limited thereto. Alternatively, the first communication link CL1a and the second communication links CL2a and CL2b may be media for transmitting analog or digital type service signals. The first communication link CL1a and the second communication links CL2a and CL2b may be any wired and/or wireless communication link such as WiMax, a network optical fiber, an Ethernet-based cable, a wired cable formed of copper, an optical link, etc.

Referring to FIG. 3B, the headend unit 160 may include a headend unit processor 315 (hereinafter referred to as an HEU processor) and a headend unit interface 320 (hereinafter referred to as an HEU interface).

The HEU interface 320 is for the headend unit 160 to transmit and receive information necessary for improving cell size constraints to and from the ORU 150, a DAS remote unit 170, and the MSE 180.

The HEU interface 320 may receive an ORU identifier and information indicating which headend unit an ORU is connected to from the ORU 150 or the MSE 180.

The HEU interface 320 may transmit delay information generated based on a measured delay (or delay time) to the farthest DAS remote unit 170 to the ORU 150.

The headend unit 160 may transmit the information described above to the O-RAN base stations 110a and 110b using a certain security protocol, for example, an HTTPS protocol.

The headend unit 130 may transmit and receive pieces of information such as allocation information to and from the DAS remote unit 170 and the MSE 180 by using the security protocol described above or another security protocol defined by a manufacturer of a distributed antenna system.

The headend unit 160 may transmit and receive the pieces of information to and from the MSE 180 and the ORU 150 connected through a first communication link CL1b and the second communication link CL2a, respectively, and the DAS remote unit 170 connected through a fifth communication link CL5, by using the HEU interface 320.

The fifth communication link CL5 may be, for example, the Internet, but is not limited thereto, and may be a medium for transmitting an analog or digital type service signal. The fifth communication link CL5 may be any wired and/or wireless communication link such as an RF cable, WiMax, etc., a network optical fiber, an Ethernet-based cable, a wired cable formed of copper, an optical link, etc.

The HEU processor 315 may include, although not shown, a controller that controls all procedures to perform an operation of a headend unit in a communication system according to an embodiment, and a converter for converting service signals.

The HEU processor 315 may measure a delay (or delay time) to the DAS remote unit 170 located farthest from at least one connected DAS remote unit 170. The HEU processor 315 may generate delay information (or delay time information) based on the measured delay (or delay time).

Referring to FIG. 3C, the DAS remote unit 170 may include a DAS remote unit interface 330 (hereinafter referred to as a DAS RU interface) and a remote unit processor 325 (hereinafter referred to as a DAS RU processor).

The DAS RU interface 330 is for transmitting and receiving information required for communicating to and from the headend unit 160, the MSE 180, and another DAS remote unit.

The DAS remote unit 170 may transmit and receive the above information to and from the headend unit 160 and the MSE 180 by using an HTTPS protocol and other security protocols, according to an embodiment.

The DAS remote unit 170 may transmit and receive the above information to and from the MSE 180, the headend unit 160, and another remote unit through a first communication link CL1c, the fifth communication link CL5, and a sixth communication link CL6, respectively, by using the DAS RU interface 330.

The sixth communication link CL6 may be, for example, the Internet, but is not limited thereto, and may be a medium for transmitting an analog or digital type service signal. The sixth communication link CL6 may be any wired and/or wireless communication link such as an RF cable, WiMax, etc., a network optical fiber, an Ethernet-based cable, a wired cable formed of copper, an optical link, etc.

The DAS RU processor 325 may include, although not shown, a controller that controls all procedures to perform an operation of the DAS remote unit 170 in a communication system according to an embodiment, and a converter for converting service signals.

The DAS RU processor 325 may perform analog and/or digital filtering, amplification, and other processing on received service signals and then transmit them to an end user terminal via a connected antenna.

Referring to FIG. 3D, the MSE 180 may include an MSE interface 335, a bus 340, and an MSE processing system 345.

The MSE interface 335 is for the MSE 180 to transmit and receive information necessary for improving cell size constraints to and from the headend unit 160, the DAS remote unit 170, and the ORU 150.

The MSE 180 may transmit and receive the information to and from the headend unit 160, the DAS remote unit 170, and the ORU 150 connected to the MSE 180 through the first communication links CL1b and CL1c and the second communication link CL2b, respectively, by using the MSE interface 335.

The bus 340 may communicatively connect the MSE interface 335 to the MSE processing system 345.

The MSE processing system 345 may include a processor 350 and a memory 355.

The processor 350 may include, although not shown, a controller that controls all procedures to perform an operation of the MSE 180 in a communication system according to an embodiment, and a converter for converting service signals.

The processor 350 may be any device suitable for executing a program command for processing various information or delay time measurements received from the O-RAN base stations 110a and 110b or a DAS through the MSE interface 335.

The processor 350 may be any device suitable for executing program commands for monitoring, managing, controlling, and operating all operating states of the O-RAN base stations 110a and 110b, or program commands for monitoring, managing, controlling, and operating all operating states of the DASs 120a and 120b.

The memory 355 may be any non-transitory medium for storing the program commands described above defining an operation of the MSE 180. For example, the memory 355 may be read-only memory (ROM), random-access memory (RAM), an optical storage, a magnetic storage, a flash memory, or any other medium.

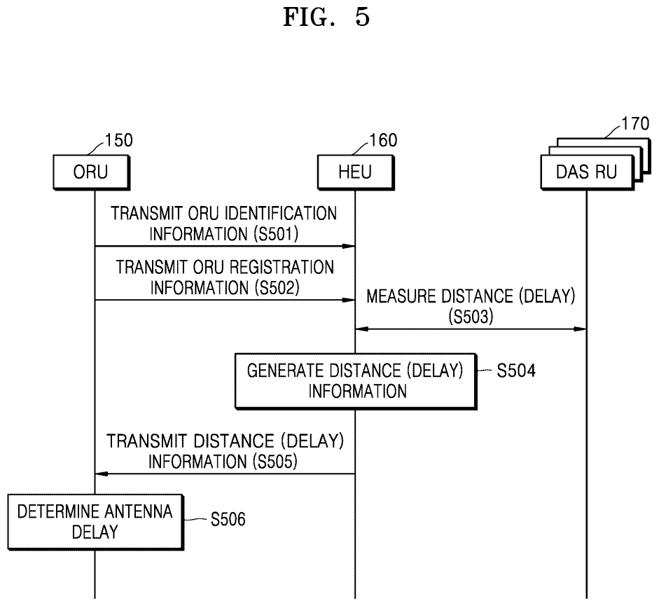

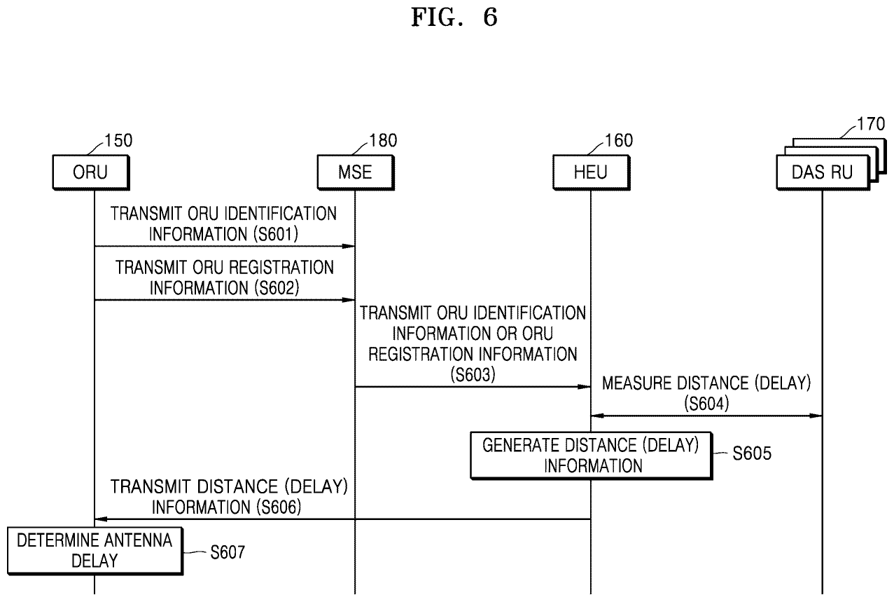

FIG. 4 is a block diagram of a communication system according to an embodiment, and FIGS. 5 and 6 are flowcharts for explaining an operating method of the communication system illustrated in FIG. 4.

In more detail, a communication system 10c illustrated in FIG. 4 exemplifies an embodiment in which a headend unit 160c of a distributed antenna system 120c is interoperable with an ORU 150c of an O-RAN base station 110c, and the ORU 150c and the headend unit 160c are communicatively connected to each other so that they may transmit and receive information necessary to determine an antenna delay value through their respective interfaces. Alternatively, an embodiment may be exemplified in which the ORU 150c and the headend unit 160c are communicatively connected to each other so that they may transmit and receive necessary information through the MSE 180b.

In FIG. 4, between the O-RAN base station 110c and the headend unit 160c, and among the headend unit 160c, a DAS remote unit 170c, and the MSE 180b constituting the distributed antenna system 120c, radio service signals provided to/from an end user terminal are transmitted as analog or digital type signals. Processes related to configurations for this will not be given herein for convenience of explanation.

In the description of FIGS. 4 to 6, the same or corresponding reference numerals as those in FIGS. 1 to 3D denote the same or corresponding elements, and therefore, repeated descriptions thereof will not be given herein. In a communication system according to the present embodiment, signal transmission and reception operations for an O-RAN base station and a distributed antenna system including the ORU 150, the headend unit 160, the DAS remote unit 170c, and the MSE 180 will be mainly described.

Referring to FIG. 4, a series of operations in the O-RAN base station 110c and the distributed antenna system 120c according to an embodiment may be performed to set a distance from an ODU 140c to a DAS remote unit 170c as a fronthaul distance 410 based on an antenna delay value determined by the ORU 150c, and a distance from the DAS remote unit 170c to the UE 130 as a cell size 420. In this case, even under the same cell constraints as before, an effect of expanding an actual cell range may occur. The above series of operations will be described in detail in FIGS. 5 and 6 below.

Referring to FIG. 5, first, the ORU 150 of an O-RAN base station may generate identification information of an ORU and registration information of an ORU. The ORU identifier may include information such as a serial number, an IP address, and RU ID of the ORU 150, a geographical location of an entity, and an installation location of an antenna. Registration information of the ORU may include information indicating which headend unit the ORU is connected to. For example, the registration information may include an SITE number (or a base station number), identifier information of the ORU (IP address, serial number, etc.), and identifier information of the headend unit (IP address, serial number, etc.). That is, the registration information may be represented as {Site #17, ORU #110.20.1.8, HE #110.20.2.1}.

Identification information generated by the ORU 150 may be considered as identification information of an O-RAN base station including the ORU 150 or an ODU connected to the ORU.

The ORU identification information may further include an identifier indicating interoperability of the ORU 150 and the headend unit 160 of a distributed antenna system. For example, the ORU identification information may include an indicator indicating that delay information is to be transmitted because the ORU 150 interoperates with the headend unit 160.

In operation S501, the ORU 150 may transmit generated ORU identification information to the headend unit 160.

In addition, in operation S502, the ORU 150 may transmit generated ORU registration information to the headend unit 160.

The headend unit 160 that receives ORU identification information or/and ORU registration information may identify an interoperable ORU 150 based on the ORU identification information or the ORU registration information. In addition, the headend unit 160 may determine whether to interoperate with the ORU 150.

In operation S503, the headend unit 160 may measure a delay (or time delay) for at least one DAS remote unit 170 connected to the headend unit 160 in a distributed antenna system. A method by which the headend unit 160 measures the delay (or time delay) for the DAS remote unit 170 may be a conventionally known method such as measuring a round trip time or reporting a communication quality measurement, and this will not be described in detail.

In operation S504, the headend unit 160 may identify a farthest DAS remote unit 170 based on the measured delay (or delay time) for at least one connected DAS remote unit 170, and may generate delay information (or distance information or delay time information) based on the information.

In operation S505, the headend unit 160 may transmit the generated delay information to the interoperable ORU 150.

In operation S506, the ORU 150 that receives the delay information may determine an antenna delay value (e.g., an external antenna delay value) based on the delay information. Once the antenna delay value is determined, the ORU 150 may reduce a buffering delay by the antenna delay value. Therefore, it can be set to have a widest cell size by considering the furthest DAS remote unit 170 and reducing a buffering delay.

Referring to FIG. 6, first, the ORU 150 of an O-RAN base station may generate identification information of an ORU and registration information of an ORU. The ORU identifier may include information such as a serial number, an IP address, and an ORU ID of the ORU 150, a geographical location of an entity, and an installation location of an antenna. Registration information of the ORU may include information indicating which headend unit the ORU is connected to. For example, the registration information may include an SITE number, identifier information of the ORU (IP address, serial number, etc.), and identifier information of the headend unit (IP address, serial number, etc.). That is, the registration information may be represented as {Site #17, ORU #110.20.1.8, HE #110.20.2.1}.

Identification information generated by the ORU 150 may be considered as identification information of an O-RAN base station including the ORU 150 or an ODU connected to the ORU.

The ORU identification information may further include an identifier indicating interoperability of the ORU 150 and the headend unit 160 of a distributed antenna system. For example, the ORU identification information may include an indicator indicating that delay information is to be transmitted because the ORU 150 interoperates with the headend unit 160.

In operation S601, the ORU 150 may transmit generated ORU identification information to the MSE 180.

In addition, in operation S602, the ORU 150 may transmit generated ORU identification information to the MSE 180.

The headend unit 160 that receives ORU identification information or/and ORU registration information from the ORU 150 may identify an interoperable ORU 150 based on the ORU identification information or ORU registration information. Further, the MSE 180 may determine whether to interoperate with the ORU 150.

In operation S603, the MSE 180 may transmit the received ORU identification information or ORU registration information to the headend unit 160 based on headend unit identifier information included in the ORU registration information.

In operation S604, the headend unit 160 that receives the ORU identification information or/and ORU registration information may measure a delay (or time delay) for at least one DAS remote unit 170 connected to the headend unit 160 in a distributed antenna system. A method by which the headend unit 160 measures the delay (or time delay) for the DAS remote unit 170 may be a conventionally known method such as measuring a round trip time or reporting a communication quality measurement, and this will not be described in detail.

In operation S605, the headend unit 160 may identify a farthest DAS remote unit 170 based on the measured delay (or delay time) for at least one connected DAS remote unit 170, and may generate delay information (or distance information, delay time information) based on the information.

In operation S606, the headend unit 160 may transmit the generated delay information to the interoperable ORU 150 through the MSE 180.

In operation S607, the ORU 150 that receives the delay information from the MSE 180 may determine an antenna delay value (e.g., an external antenna delay value) based on the delay information. Once the antenna delay value is determined, the ORU 150 may reduce a buffering delay by the antenna delay value. Therefore, it can be set to have a widest cell size by considering the furthest DAS remote unit 170 and reducing a buffering delay.

FIGS. 4 and 5 describe the embodiment in which the headend unit 160 interoperates with the ORU 150 of an O-RAN base station above. However, even in an embodiment in which at least one DAS remote unit 170 interoperates with at least one radio service device, operations such as those in FIGS. 4 to 6 will be possible.

Further, the methods described with reference to FIGS. 4 to 6 include one or more operations or actions for achieving the methods. The operations and/or actions for achieving the methods may be interchanged with one another without departing from the scope of the claims. In other words, the order and/or use of specific operations and/or actions may be modified without departing from the scope of the claims, unless a certain order for the operations and/or actions is specified.

In addition, various operations of the methods described above may be performed by any suitable means capable of performing corresponding functions. The means includes, but is not limited to, various hardware and/or software components and/or modules such as an ASIC or a processor. In general, when there are operations corresponding to the drawings, these operations may have a corresponding counterpart and functional components having the same number as the number of the counterpart.

The various illustrative logic blocks, components, or circuits described in connection with the disclosure may be implemented or performed by a general-purpose processor designed to perform the functions disclosed herein, a digital signal processor (DSP), an ASIC, a field-programmable gate array (FPGA) or other programmable logic device (PLD), a discrete gate or transistor logic device, discrete hardware components, or any combination thereof. The general-purpose processor may be a microprocessor, but may alternatively be any commercially available processor, controller, microcontroller, or state machine. The processor may also be implemented in a combination of computing devices, for example, a combination of the DSP and the microprocessor, a plurality of microprocessors, one or more microprocessors in connection with a DSP core, or any other configuration.

The term “determine” includes a wide variety of actions. For example, the term “determine” may include computing, processing, deriving, examining, looking up (e.g., looking up in a table, database, or other data structure), identifying, and the like. The term “determine” may also include receiving (e.g., receiving information), accessing (accessing data in a memory), and the like. The term “determine” may also include resolving, selecting, choosing, establishing, and the like.

Numerous modifications and adaptations will be readily apparent to one of ordinary skill in the art without departing from the spirit and scope of the disclosure.

Accordingly, the embodiments illustrated in the disclosure are not intended to limit the inventive concept of the disclosure but are for illustrative purposes, and the scope of the inventive concept of the disclosure is not limited by these embodiments.

The scope of protection of the inventive concept of the disclosure should be interpreted in accordance with the claims below, and all technical ideas within the equivalent scope should be construed as being included in the scope of inventive concept of the disclosure.

1. A method performed by a first distributed antenna system (DAS) node unit in a communication system including a DAS, the method comprising:
measuring information related to a delay of at least one second DAS node unit connected to the first DAS node unit;
generating delay information for the at least one second DAS node unit based on the information related to the delay; and
transmitting the delay information to an open-radio access network (O-RAN) node unit of a base station to which the DAS is connected.

2. The method of claim 1, further comprising:
receiving identification information indicating the O-RAN node unit from the O-RAN node unit.

3. The method of claim 2, wherein the identification information comprises a serial number and an IP address of the O-RAN node unit.

4. The method of claim 1, further comprising:
receiving registration information indicating that the O-RAN node unit is connected to the first DAS node unit from the O-RAN node unit.

5. The method of claim 4, wherein the registration information comprises a number of the base station, identification information of the O-RAN node unit, and identification information of the first DAS node unit.

6. The method of claim 5, wherein the identification information of the O-RAN node unit comprises an IP address or serial number of the O-RAN node unit, and
the identification information of the first DAS node unit comprises an IP address or serial number of the first DAS node unit.

7. A method performed by an open-radio access network (O-RAN) node unit in a communication system including a distributed antenna system (DAS), the method comprising:
transmitting identification information of the O-RAN node unit to a first DAS node unit included in the DAS;
receiving delay information from the first DAS node unit; and
determining an antenna delay value based on the delay information.

8. The method of claim 7, further comprising:
transmitting registration information indicating that the O-RAN node unit is connected to the first DAS node unit to the first DAS node unit.

9. The method of claim 8, wherein the registration information comprises a number of a base station including the O-RAN node unit, the identification information of the O-RAN node unit, and identification information of the first DAS node unit,
the identification information of the O-RAN node unit comprises an IP address or serial number of the O-RAN node unit, and
the identification information of the first DAS node unit comprises an IP address or serial number of the first DAS node unit.

10. The method of claim 7, wherein the identification information comprises the serial number and IP address of the O-RAN node unit, and
the O-RAN node unit is a distributed unit of a base station that is communicatively connected to the first DAS node unit.

11. A method performed by a first distributed antenna system (DAS) node unit in a communication system including a DAS, the method comprising:
measuring information related to a delay of at least one second DAS node unit connected to the first DAS node unit;
generating delay information for the at least one second DAS node unit based on the information related to the delay; and
transmitting the delay information to an open-radio access network (O-RAN) node unit of a base station to which the DAS is connected through a DAS management system entity.

12. The method of claim 11, further comprising:
receiving identification information indicating the O-RAN node unit from the O-RAN node unit of the base station through the DAS management system entity.

13. The method of claim 12, wherein the identification information comprises a serial number and an IP address of the O-RAN node unit.

14. The method of claim 11, further comprising:
receiving registration information indicating that the O-RAN node unit is connected to the first DAS node unit from the O-RAN node unit through the DAS management system entity.

15. The method of claim 14, wherein the registration information comprises a number of the base station, identification information of the O-RAN node unit, and identification information of the first DAS node unit.

16. The method of claim 15, wherein the identification information of the O-RAN node unit comprises an IP address or serial number of the O-RAN node unit, and
the identification information of the first DAS node unit comprises an IP address or serial number of the first DAS node unit.

17. A method performed by an open-radio access network (O-RAN) node unit in a communication system including a distributed antenna system (DAS), the method comprising:
transmitting identification information of the O-RAN node unit to a DAS management system entity;
receiving delay information from the DAS management system entity; and
determining an antenna delay value based on the delay information.

18. The method of claim 17, further comprising:
transmitting registration information indicating that the O-RAN node unit is connected to a first DAS node unit of the DAS to the DAS management system entity.

19. The method of claim 18, wherein the registration information comprises a number of a base station including the O-RAN node unit, the identification information of the O-RAN node unit, and identification information of the first DAS node unit,
the identification information of the O-RAN node unit comprises an IP address or serial number of the O-RAN node unit, and
the identification information of the first DAS node unit comprises an IP address or serial number of the first DAS node unit.

20. The method of claim 17, wherein the identification information comprises the serial number and IP address of the O-RAN node unit, and
the O-RAN node unit is a distributed unit of a base station that is communicatively connected to the DAS management system entity.
